(19) United States
(12) Patent Application Publication
(10) Pub. No.: US 2018/0192428 A1
(43) Pub. Date: Jul. 5, 2018

(54) QUALITY OF SERVICE DEPENDENT HYBRID BEAMFORMING TRAINING AND MULTIUSER SCHEDULING

(71) Applicant: Intel Corporation, Santa Clara, CA (US)

(72) Inventors: Roya DOOSTNEJAD, Los Altos, CA (US); Dave CAVALCANTI, Beaverton, OR (US); Carlos CORDEIRO, Portland, OR (US)

(21) Appl. No.: 15/394,334

(22) Filed: Dec. 29, 2016

(51) Int. Cl. H04W 72/12; H04W 72/08; H04W 72/04; H04B 7/06; H04B 7/04

(52) U.S. Cl. CPC H04W 72/121; H04W 72/085; H04W 72/046; H04W 72/0466; H04B 7/0617; H04B 7/0452; H04B 7/0632

(57) ABSTRACT

A device is disclosed that may cause to send a network acquisition frame to a first device and a second device. The device may cause to send a first beamforming training frame to the first device and a second beamforming training frame to the second device. The device may determine a first set of RF chains, from a multi-antenna array, to establish a first connection on with the first device. The device may determine a first codebook to transmit to the first device, and a second codebook to transmit to the second device. The device may cause to send the first codebook to the first device, and the second codebook to the second device. The device may cause to send a first set of data to the first device on the primary channel, and a second set of data to the second device on the first set of channels.

### TECHNICAL FIELD

This disclosure generally relates to systems and methods for wireless communications and, more particularly, quality of service (QoS) based resource management in millimeter wave (mmWave) multiuser wireless communications systems.

### BACKGROUND

In mmWave communications, highly directional transmissions are essential to compensate the intensive signal attenuation. Therefore, beamforming (BF) is a key component for mmWave communications, and it is essential for initial acquisition. Beam and user acquisition is based on sequential sector sweep training where a Base Station (BS) and user equipment (UE) sequentially transmit a synchronization signal (SS) beamformed in different angles over different time symbols to determine the best connection and direction. In a superframe (beacon period in IEEE 802.11 ad), there is an analog BF training period before data transmission. The duration of analog BF training is a function of the number of training code words, beam width, and number of users. The beam width is also a function of the number of antennas and the code words. In conventional training algorithms, the same set of code words and BF parameters (e.g. beam width, training time, etc.) are considered for all users in the network. Depending on one or more QoS requirements associated with different UE different sets of code words and BF parameters may be reserved for the different UE and the associated QoS requirements.

### BRIEF DESCRIPTION OF THE DRAWINGS

FIG. 1 depicts a multiple antenna array beamforming architecture, according to one or more example embodiments of the disclosure.

FIG. 2 depicts an illustrative high throughput (HT) synchronization frame, according to one or more example embodiments of the disclosure.

FIG. 3 depicts an illustrative high reliability low latency (HRLL) synchronization frame, according to one or more example embodiments of the disclosure.

FIG. 4 depicts an illustrative multi-channel hybrid data transmission to (HT) and (HRLL) user equipment (UE) in different channels, according to one or more example embodiments of the disclosure.

FIG. 5 an illustrative flow diagram for beamforming training for different Quality of Service (QoS) users, according to one or more example embodiments of the disclosure.

FIG. 6 depicts an illustrative flow diagram for beamforming training for a QoS user, according to the disclosure.

FIG. 7 depicts an illustrative flow diagram for beamforming training for a QoS user, according to the disclosure.

FIG. 8 illustrates a functional diagram of an example communication station that may be suitable for use as a user device, in accordance with one or more example embodiments of the disclosure.

FIG. 9 is a block diagram of an example machine upon which any of one or more techniques (for example, methods) may be performed, in accordance with one or more embodiments of the disclosure.

### DETAILED DESCRIPTION

Determining beamforming (BF) parameters including a number of RF chains associated with a user, beam width, and analog BF training periods are key factors in defining latency, as well as reliability metrics for millimeter wave (mmWave) communications, and also for channel access over multiple channels. The resource management techniques disclosed herein may be used to service different user types with different requirements (e.g., Quality of Service (QoS)). Time sensitive networks (TSN) s are examples of low latency networks and high reliability in which users may have low latency requirements, and as such the resource management techniques disclosed herein may help achieve reductions in the latency experienced by devices executing applications requiring performance metrics commensurate with a TSN.

In some embodiments, QoS dependent resource allocation schemes, multi-channel hybrid beam training, and multiuser beamforming in a network with divergent/multiple QoS requirements may be used to help achieve low latency or high reliability requirements of UE, whichever the case may be for user applications executing on a user's UE, based on the QoS requirements of the executing applications. In particular, the methods, systems, and devices disclosed herein use resources (e.g., BF training, beam width, and scheduling) to minimize training time for UE to begin executing latency applications. The methods, systems, and devices may also, in addition to reducing the BF training time to help reduce latency, ensure or guarantee that services with high reliability are provided to UE executing applications requiring degree of reliability. The methods, systems, and devices disclosed herein may enable UE with low latency requirements and UE with high reliability requirements to exchange data with and access points (APs) simultaneously based on QoS requirements. In some current systems, APs execute BF training the same way regardless of the QoS requirements of the UE. For example, if there is a first set of UE executing applications that connect to TSNs requiring low latency (LL) and high reliability (HR) QoS connections, and a second set of UE executing applications requiring high throughput QoS connections, at the expense of LL and HR (e.g., User Datagram Protocol (UDP) networks), existing IEEE 802.11 APs may perform the same BF training sequences for the first set of UE and the second set of UE regardless of their QoS requirements. As a result, there are no QoS dependent resource allocation and/or network management for different UE requiring different types of QoS, thereby degrading the experience of the UE with LL and HR QoS requirements.

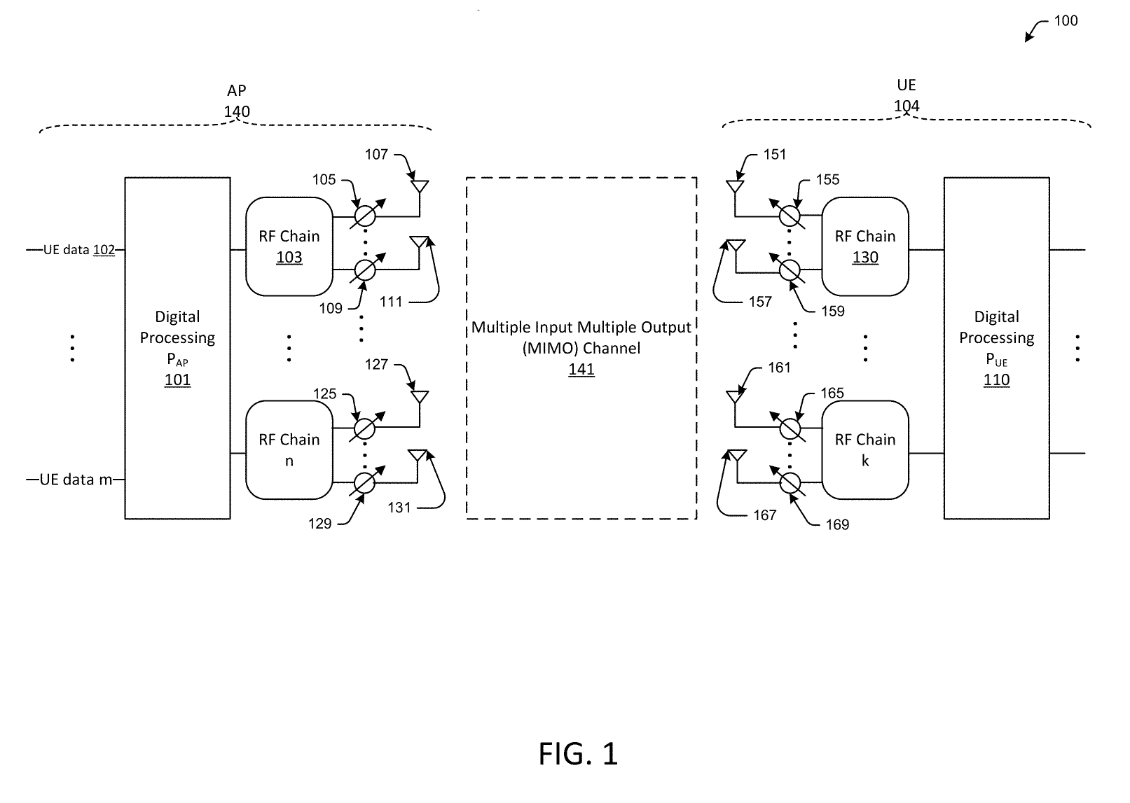

In mmWave communications, for frequencies higher than 6 GHz (e.g. 28, 60 GHz), array gain is necessary to compensate for very high path loss. Therefore, beamforming is a key enabling technology for UE to both acquire a connection to an AP and to maintain that connection for data transmission. In some embodiments of WiGig/IEEE 802.1 lay and also 5^{th} Generation Cellular (5G) mmWave, hybrid beamforming architectures (combination of analog BF and Digital BF) may be used for networks in which there are more than one RF chain at both the (AP) and user (UE), as shown in FIG. 1.

The AP and UE may rely on a pre-designed codebook to conduct beamforming for analog BF. The BF training time may be a function of the beam width and codebook dimension. In other words, a larger number of antennas generate higher array gain and narrower beam width which requires larger codebook for full spatial coverage. Array gain may be the average combined power of signals received at the UE, comprising a multi-antenna array, from a multi-antenna array in an AP, relative to the individual average power received on an antenna in the UE. The array gain may also be associated with the diversity gain related to the probability that a connection between one or more of the antennas in the multi-antenna AP array and one or more of the antennas in the multi-antenna UE array is severed. The diversity gain may be dependent on spatial correlation coefficients between signals transmitted on different antenna of the multi-antenna AP or UE array. In some embodiments, the antennas in the multi-antenna arrays, of the AP or UE, may transmit signals using a narrow bandwidth which may result in higher throughput because the signal power may be concentrated in a smaller area resulting in a higher total channel capacity and therefore throughput. For example, an antenna in which the beam width is thirty degrees has a higher number of electromagnetic particles concentrated in a smaller area resulting in a higher total power corresponding to signals transmitted between the transmitting antenna and the receiving antenna than an antenna in which the beam width is ninety degrees. Accordingly, because the channel capacity may correspond to the product of the bandwidth available to exchange signals between antennas (e.g., system bandwidth), and 1 plus the signal to noise ratio of transmitting antenna, the channel capacity, and therefore the throughput, may be greater for a narrower bandwidth than it may be for a wider bandwidth.

Returning to the example of a beam width of thirty degrees as compared to a beam width of ninety degrees, because

$$C = B log ( 1 + \frac{{S}_{p}}{N} ) ,$$

wherein C may be referred to as the channel capacity, B may be referred to as the channel bandwith, S_{P} may be referred to as the received signal power, and N may be referred to as the noise, and because the received signal power for a smaller beam width (thirty degrees) will be greater than that for a larger beam width (ninety degrees), that is S_{P} for a thirty degree beam width will be greater than S_{P} for a ninety degree beam width, C will be greater for a thirty degree beam width than a ninety degree beam width. Accordingly, a first set of UE antenna(s) exchanging signals with a first set of antennas of the multi-antenna array of the AP may experience a higher throughput than as second set of UE antenna(s) exchanging signals with a second set of antennas of the multi-antenna array of the AP wherein the first set of antennas of the multi-antenna array may transmit/receive signals over a smaller beam width than that of the second set of antennas of the multi-antenna array.

The second set of UE antenna(s) however may experience a higher reliability however, because the beam width associated with the second set of antennas may cover a larger area and therefore increase the area over which the UE can successfully transmit signals to the AP and receive signals from the AP. The UE may also experience lower latency as well, because the UE will not have to go through multiple association processes in order to associate with multiple antennas in the first set of antennas of the multi-antenna array of the AP. That is, for each antenna in the first set of UE antenna(s) attempting to connect to a corresponding antenna in the first set of antennas of the multi-antenna array of the AP, there may be an association process associated with the attempted connection thereby increasing the amount of time (latency) that the UE may have to wait in order to begin transmitting/receiving data. Because the signal power, and therefore the throughput, of the first set of antennas of the multi-antenna array of the AP is greater than that of the second set of antennas of the multi-antenna array of the AP the first set of antennas of the multi-antenna array of the AP may be said to have a higher antenna gain than that of the second set of antennas of the multi-antenna array of the AP.

In some embodiments, the beam width may be inversely proportional to the number of antennas and may be expressed as

$$beam width = \frac{102}{n}$$

wherein the beam width is expressed in degrees, and n is the number of antennas. Thus as the number of antennas increases the beam width per antenna decreases. The antenna array gain may have a non-linear relationship with the number antennas, and in particular may be equal to 10×log₁₀ n. That is the antenna array gain may be determined based on the number of antennas in an array, and may be expressed in decibels (dBs).

A codebook may be used by the AP and UE to identify different beam widths. In particular, a multi-resolution codebook for analog BF may be used with variable half power beam width (HPBW). The HPBW may be controlled by the codebook, through a beam broadening approach, while the same number of antennas may still be employed. This may provide higher array gain and transmit/receive power for the wider beam case as well. This codebook provides the flexibility to select beam width and BF training for multiple scenarios. In addition to using a codebook to select different beam widths (sectors) over which transmission/reception may occur, the IEEE standard 802.11 ay has adopted channel access over multiple channels, thereby making it possible for the methods, systems, and devices disclosed herein to not only leverage the codebook to select different beam widths over which to exchange signals, but also to select multiple channels over which devices may access the channel to communicate with one another. In some embodiments, an AP may simultaneously transmit to multiple UE allocated to different channels individually, wherein each antenna may have a channel assigned to it. In other embodiments, each antenna may have more than one channel assigned to it.

In mmWave wireless communication (e.g., WiGig/IEEE 802.1 lay and 5G mmWave) there are different types of UE with different QoS requirements, and efficient multiuser schemes and resource allocation algorithms are necessary to satisfy these different QoS requirements. In general there may be two types of UE that may simultaneously access and use the network.

The first may be a high throughput (HT) UE wherein the UE, or application executing on the UE, requires a higher array gain and therefor more frequent beam training, and tracking. The UE may require more beam training and tracking, because as explained above, the antennas associated with the UE may have to go through an association process with each of the antennas of the multi-antenna array of the AP that transmit/receive signals on a narrower band than the other antennas of the multi-antenna array of the AP. The antennas in the UE and AP that transmit/receive signals on the narrower band may be referred to as HT antennas. After the HT UE antennas are associated with the HT AP antennas the HT UE antennas must go through a beam training process to learn the state of the channel between the HT UE antennas and the HT AP antennas, which may increase the amount of time (latency) experienced by applications executing on the UE. The HT UE antennas also must track the HT AP antennas as applications executing on the UE are transmitting/receiving data to/from the AP. This also increases the latency associated with the execution of the applications on the UE. As a result, the UE may participate in a user access procedure wherein the UE is not guaranteed a requested QoS. For example, an application executing on the UE may require a Universal Datagram Protocol (UDP) connection to a server connected to the AP hosting a service associated with the executing application, wherein no acknowledgement (ACK) frames are ever exchanged between the UE and the server. The executing application and the server will continuously exchange frames based on the next step in the series of executable instructions associated with the application and the service. For example, the application may be a streaming media application such as an IPTV application, which may require a high throughput, and therefore the UE antennas may require a narrower beam width that supports the bandwidth requirements of the IPTV application executing on the UE and the IPTV service hosted on the server. Accordingly, the array gain will be higher.

The second user may be a high reliability low latency (HRLL) UE, which may require reserved channels to guarantee the service, may not require high array gain but reliability must be guaranteed, cannot tolerate interference from other signal transmissions, may have less mobility than that of a HT UE which may result in less frequent beam training and tracking. As mentioned above a Time Sensitive Network (TSN) may be used. For example, an automated assembly line may be a TSN that utilizes resource reservation protocol to ensure that materials or parts that are to be assembled are assembled at exactly the correct time. The TSN may require that there be low latency to ensure that any timing requirements for the automated assembly line are met.

In order to ensure that HT UE and HRLL UE can both be serviced in unison, wherein the HT UE may have a different set of QoS requirements to those of the HRLL UE, hybrid beamforming techniques executed on UE and APs leveraging a multiple input multiple output (MIMO) architecture are described herein.

FIG. 1 depicts a multiple antenna array beamforming architecture, according to one or more example embodiments of the disclosure. Network 100 illustrates a multiple input multiple output (MIMO) access point (AP) (e.g., AP 140), MIMO user equipment (UE) (e.g., UE 104), and a channel (e.g., MIMO channel 141), that may be representative of the media between AP 140 and UE 104 over which wireless transmissions between AP 140 and UE 104 may be exchanged.

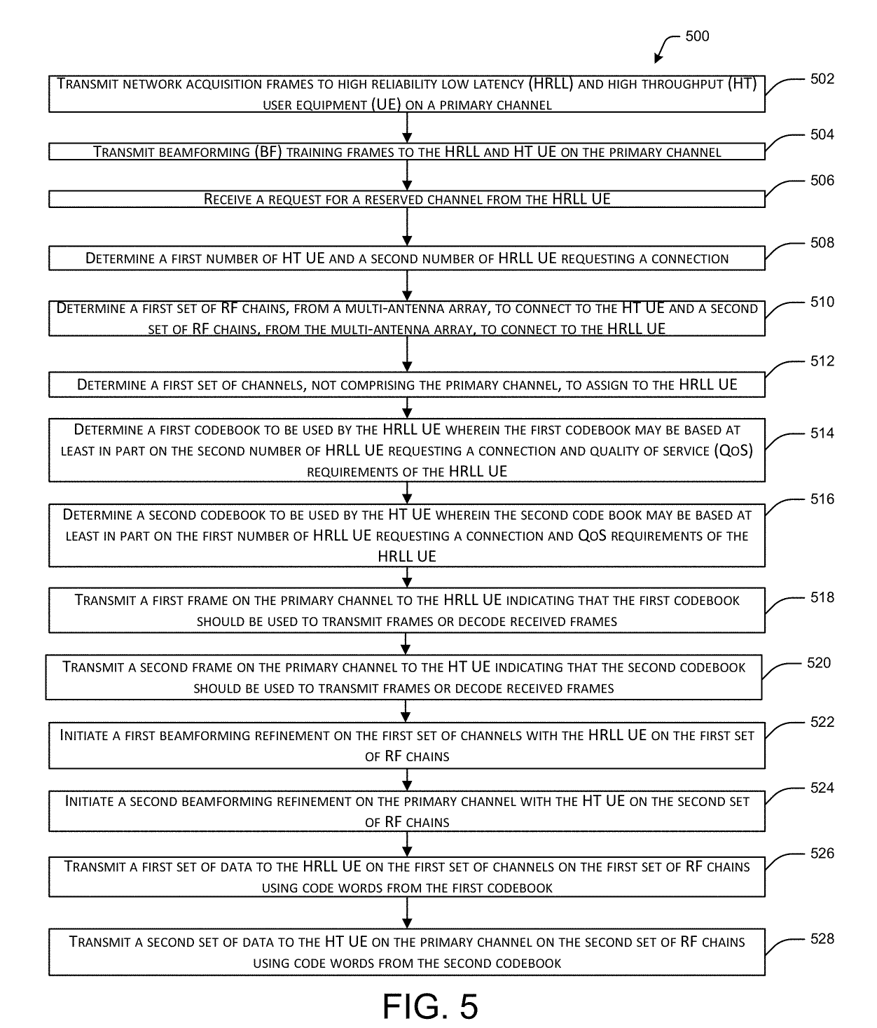

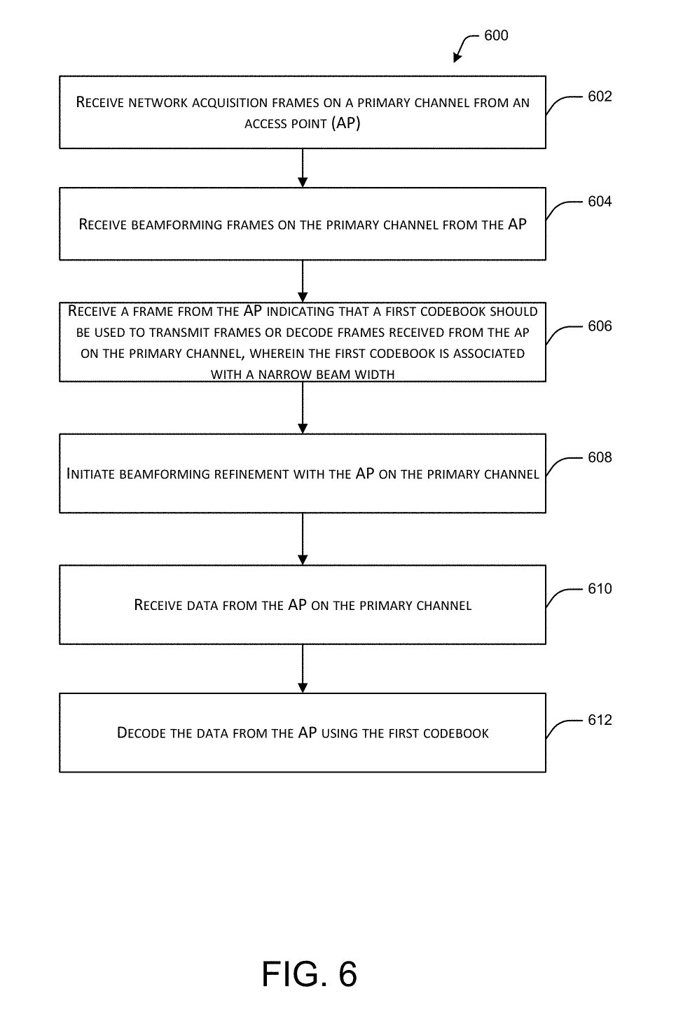

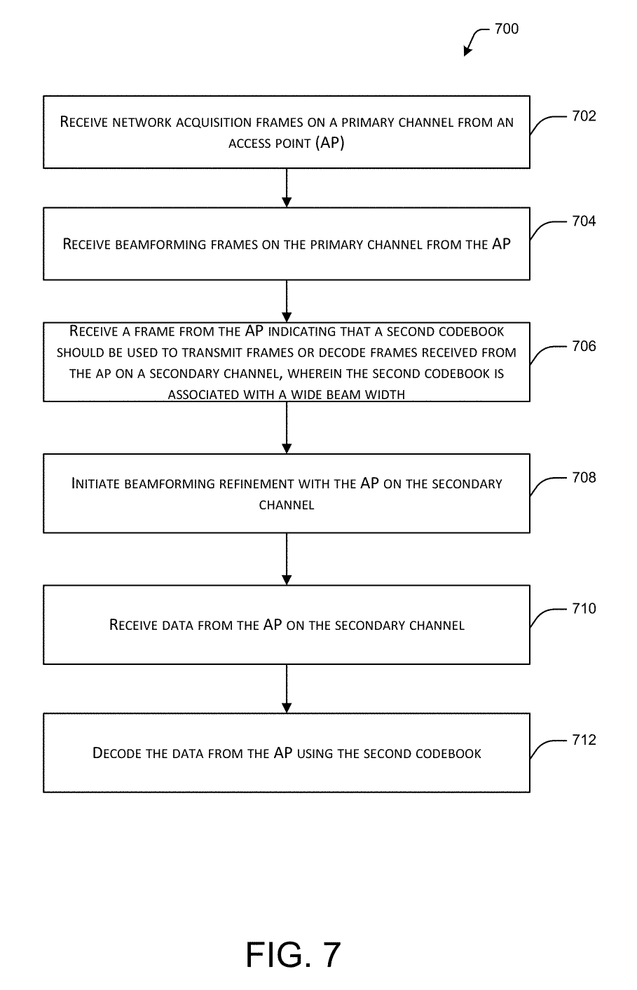

AP 140 may comprise, digital processing P_{AP} 101, RF chains 103 to RF chain n, and for each RF chain phase shifters (e.g., respective phase shifter 105-109 to phase shifters 125-129, and respective antennas 107-111 to antennas 127-131), and UE data 102 to UE data m. Digital processing P_{AP} 101 may receive, for example, UE data 102 to UE data m in the form of binary digits (bits), in parallel, from one or more processors associated with AP 140 communicating control plane, management plane, or data plane data. Control plane and management plane data may be associated with the establishment, control, and management of the UE (e.g., UE 104) attempting to connect to and/or connected to AP 140. Some of the steps in FIGS. 5-7 may be control plane data or management plane data, and others may be data plane data (e.g., steps 526 and 528 in FIG. 5, steps 610 and 612 in FIG. 6, and steps 710 and 712 in FIG. 7). UE data 102 to UE data m may be data that may be encoded based at least in part on MIMO channel 141 characteristics by Digital Processing P_{AP} 101. MIMO channel 141 characteristics may include frequency selectiveness or delay spread parameters associated with MIMO channel 141. Digital processing P_{AP} 101 may encode UE data 102 to UE data m, and transmit UE data 102 to UE data m on RF chain 103-n. In some embodiments, all of a UE data may be transmitted on a single RF chain, and in other embodiments portions of the UE data may be transmitted on multiple RF chains. This may be referred to as spatial diversity or spatial multiplexing. RF chain 103-m may generate analog signals corresponding to a mapping of the output bits from digital processing P_{AP} 101 to analog signals. For example, UE data 102 may be encoded by digital processing P_{AP} 101 and the output, which may be a first bit sequence, may be mapped by RF chain 103 to a second bit sequence corresponding to digital modulation constellation points, wherein a hardware component or circuit in RF chain 103 may generate an analog signal corresponding to each of the digital modulation constellation points. This may also be done with the remaining UE data by the remaining RF chains. Each of the analog signals may have been modulated to have the same frequency, and phase shifters 105-109 to phase shifters 145-129 may shift the analog signals by a predetermined phase thereby creating a difference in the transmitted analog signals in frequency. For example an analog signal transmitted on antenna 107 may be transmitted at with a different phase than a signal transmitted on antenna 111 because the phase associated with phase shifter 105 may be different to that of phase shifter 109. This may also be the case with the remaining phase shifters. The phase associated with each phase shifter may be based at least in part on steering a beam toward a UE antenna (e.g., antenna 151) in order to maximize received power at antenna 151. This may be similarly done by the other phase shifters. The phase shifters may adjust the phase of the analog signals by an amount based not only on the location of a UE antenna relative to an AP antenna, but also based on channel state information associated with the channel between the AP and UE. That is, phase shifters 105-109 to phase shifter 125-129 may determine the phases by which analog signals may be shifted based at least in part on characteristics associated with MIMO channel 141.

Analog signals received on antennas 151-167 may be transmitted on a waveguide to respective phase shifters 155-169, and may adjust the phase of the received analog signal so that the frequency of the receive signal matches that of the frequency of the analog signals output by respective RF chains 103-n. That is, the frequency at which the received analog signals that are output by phase shifters 155-169 to RF chains 130-k may oscillate at the same frequency at which the analog signals output by RF chains 103 to RF chain n oscillate. RF chain 130-k may map each phase shifted analog signal to a digital modulation constellation point and each digital modulation constellation point may be demodulated to recover the data encoded by digital processing P_{AP} 101. That is, RF chains 130-k may demodulate each digital modulation constellation point, thereby producing encoded data corresponding to the data encoded by digital processing P_{AP} 101 which may be output to digital processing P_{UE} 110 which may decode the encoded data and may recover data transmitted by digital processing P_{AP} 101 for UE 104. Digital processing P_{UE} 110 may transmit the decoded data to an application executing on UE 104. Although the example of FIG. 1 describes AP 140 as the transmitting device and UE 104 as the receiving device, UE 104 may also perform the same actions as AP 140 when transmitting signals to AP 140, and when receiving signals. That is, each of the components (antennas, phase shifters, RF chains, digital processing) of UE 104 may comprise similar hardware, firmware, and/or software to the components in AP 140. The components may perform the same operations as the components in AP 140 as well.

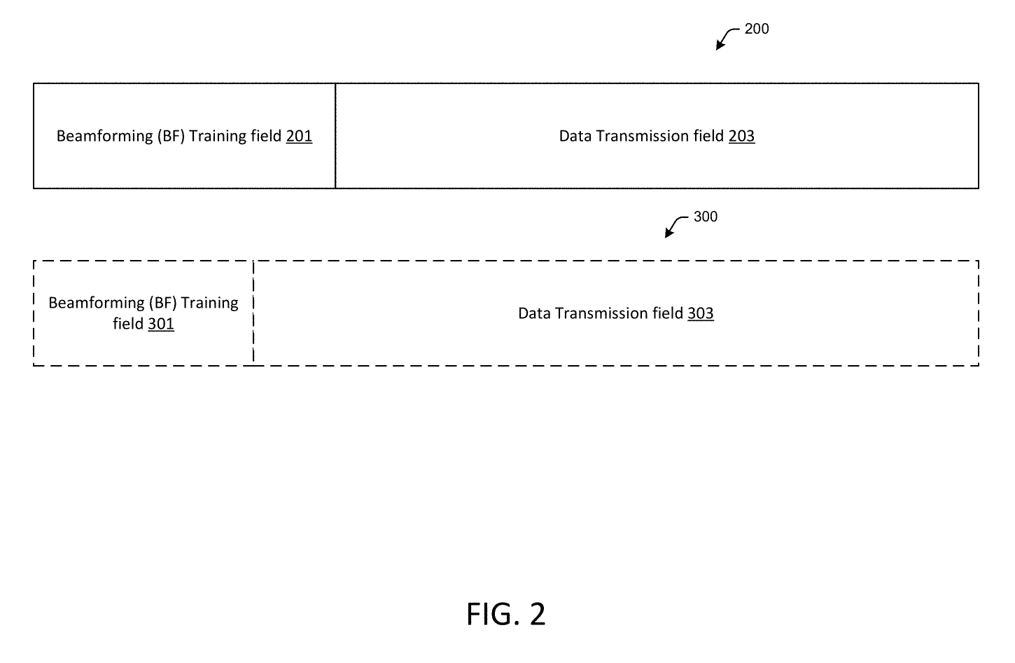

FIG. 2 depicts an illustrative high throughput (HT) synchronization frame 200, according to one or more example embodiments of the disclosure. A HT synchronization frame may be used to synchronize HT UE on a first channel reserved for HT UE, using one or more first beamforming techniques and/or beam steering techniques. For example, HT UE may determine the one or more first beamforming vectors, or an AP that the HT UE are attempting to associate with may determine the one or more first beamforming vectors, that may assist the UE in determining the appropriate array gain to synchronize the HT UE with the AP. For instance, HT UE may use a first set of beamforming vectors to determine an appropriate array gain to synchronize with the AP. As may be seen in FIG. 2 HT synchronization frame 200 and HRLL synchronization frame 300 may comprise BF training fields and data transmission fields, wherein the respective BF training fields and data transmission fields may be different lengths because they comprise a different number of bits. The BF training field of HT synchronization frame 200 may comprise more bits than the BF training field of HRLL synchronization frame 300. The reason why the number of bits in the BF training field of a HT synchronization frame is greater than the number of bits in the HRLL synchronization frame is because, as mentioned above, a narrow beam width (e.g., thirty degrees) may result in a higher received signal power at a HT UE. As a result, the channel capacity and therefore throughput will be greater than that of a HRLL UE. Consequently, a greater number of bits may be transmitted in the BF training field in order for a HT UE to tune their antennas such that the antenna array gain corresponds to the first beamforming vectors. Because the HT synchronization frame and HRLL synchronization frame comprise the same number fixed of bits, the data transmission field of the HT synchronization field may be less than that of the HRLL synchronization field. Synchronization frame 200 may comprise a beamforming (BF) training field (e.g., beamforming (BF) training field 201) and a data transmission field (e.g., data transmission field 203). BF training field 201 may comprise beamforming training sequences which may be transmitted in certain beam sectors/width directions which may be created by changing antenna weights associated with an antenna array gain. BF training field 201 may comprise one or more training symbols that may be used by an AP or UE to steer a beam transmitted from the antennas of a first device (e.g., AP 140) to the antennas of a second device (e.g., UE 104) in a direction that will maximize the received signal strength for the first and second device. Data transmission field 203 may comprise data plane data comprising data to be transmitted from an AP to UE or vice versa. For example, data transmission field 203 may comprise data associated with an application executing on the UE. For instance, UE 104 may be executing an application requiring high throughput (HT) such as an IPTV application and therefore may require access to a set of antennas on AP 140 with a high array gain. Consequently, the number of antennas, and in particular the RF chains of AP 140, that each antenna and RF chain of UE 104 must connect to in order to increase the array gain should also increase, because the array gain is a function of the number of antennas and RF chains of AP 140 that the antennas and RF chains of UE 104 are connected to. As explained above the antenna array gain may be equal to the logarithm of the number of antennas and RF chains of AP 140 that the antennas and RF chains of UE 104 are connected to. BF training field 201 may be longer than that for a high reliability low latency (HRLL) UE, because the number of antennas and RF chains of the AP that the antennas and RF chains of the UE that need to be connected to is greater therefore requiring a longer period of time for beamforming training for HT UE as opposed to HRLL UE.

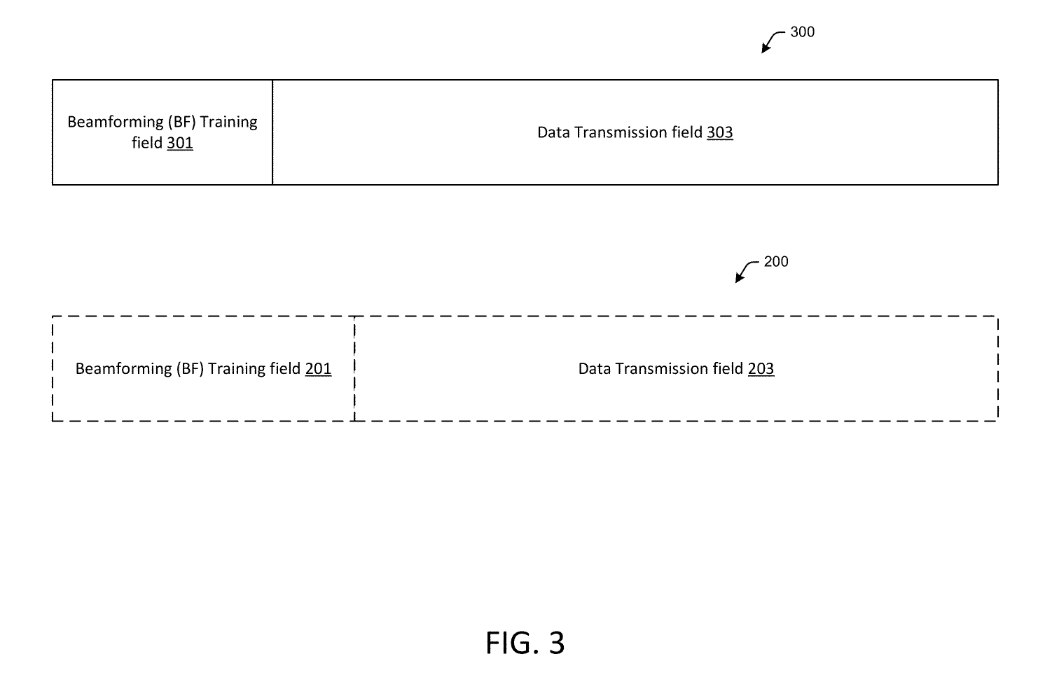

FIG. 3 depicts an illustrative high reliability (HRLL) synchronization frame 300, according to one or more example embodiments of the disclosure. A HRLL synchronization frame may be used to synchronize HRLL UE on a second channel reserved for HRLL UE, using one or more second beamforming techniques and/or beam steering techniques. For example, HRLL UE may determine the one or more second beamforming vectors, or an AP that the HRLL UE are attempting to associate with may determine the one or more second beamforming vectors, that may assist the HRLL UE in determining the appropriate array gain to synchronize the HRLL UE with the AP. For instance, HRLL UE may use a second set of beamforming vectors to determine an appropriate array gain to synchronize with the AP. As may be seen in FIG. 3 HT synchronization frame 200 and HRLL synchronization frame 300 may comprise BF training fields and data transmission fields, wherein the respective BF training fields and data transmission fields may be different lengths because they comprise a different number of bits. The BF training field of HRLL synchronization frame 300 may comprise less bits than the BF training field of HT synchronization frame 200. The reason why the number of bits in the BF training field of a HRLL synchronization frame is less than the number of bits in the HT synchronization frame is because, as mentioned above, a wider beam width (e.g., ninety degrees) may result in a lower received signal power at a HRLL UE. As a result, the channel capacity and therefore throughput will be lower than that of a HT UE. Consequently, fewer bits may be transmitted in the BF training field in order for a HRLL UE to tune their antennas such that the antenna array gain corresponds to the second beamforming vectors. Because the HRLL synchronization frame and HT synchronization frame comprise the same fixed number of bits, the data transmission field of the HRLL synchronization field may be greater than that of the HT synchronization field. The synchronization frame 300 may comprise a beamforming (BF) training field (e.g., beamforming (BF) training field 301) and data transmission field 303. BF training field 301 may comprise BF training field 301 may comprise one or more training symbols that may be used by an AP or UE to steer a beam transmitted from the antennas of a first device (e.g., AP) to the antennas of a second device (e.g., UE) in a direction that will maximize the received signal strength for the first and second device. Data transmission field 303 may comprise data plane data comprising data to be transmitted from an AP to UE or vice versa. For example, data transmission field 303 may comprise data associated with an application executing on UE. For instance, UE 104 may be executing an application requiring high reliability and low latency (HRLL) such as a Time Sensitive Network (TSN) industrial automation application and therefore may require access to a set of antennas on AP 140 providing a large physical area of coverage with high reliability and low latency. Consequently, the number of antennas, and in particular the RF chains of AP 140, that each antenna and RF chain of UE 104 must connect to may not be as has that for a HT application and therefore the array gain for a HRLL application may be lower than that of a HT application. As explained above the antenna array gain may be equal to the logarithm of the number of antennas and RF chains of AP 140 that the antennas and RF chains of UE 104 are connected to. BF training field 201 may shorter than that for a HT application executing on UE, because the number of antennas and RF chains of the AP that the antennas and RF chains of the UE that need to be connected to is less than that for a HRLL application executing on the UE. As result, a shorter period of time for beamforming training for HRLL UE may be required as opposed to applications requiring a HT. BF training 301 is smaller in length than that of BF training 201, and that is because the number of antennas required by a UE executing a HRLL application may be less than that of a UE executing a HT application and therefore less time is required to perform BF training for the UE executing the HRLL application as opposed to the UE executing the HT application.

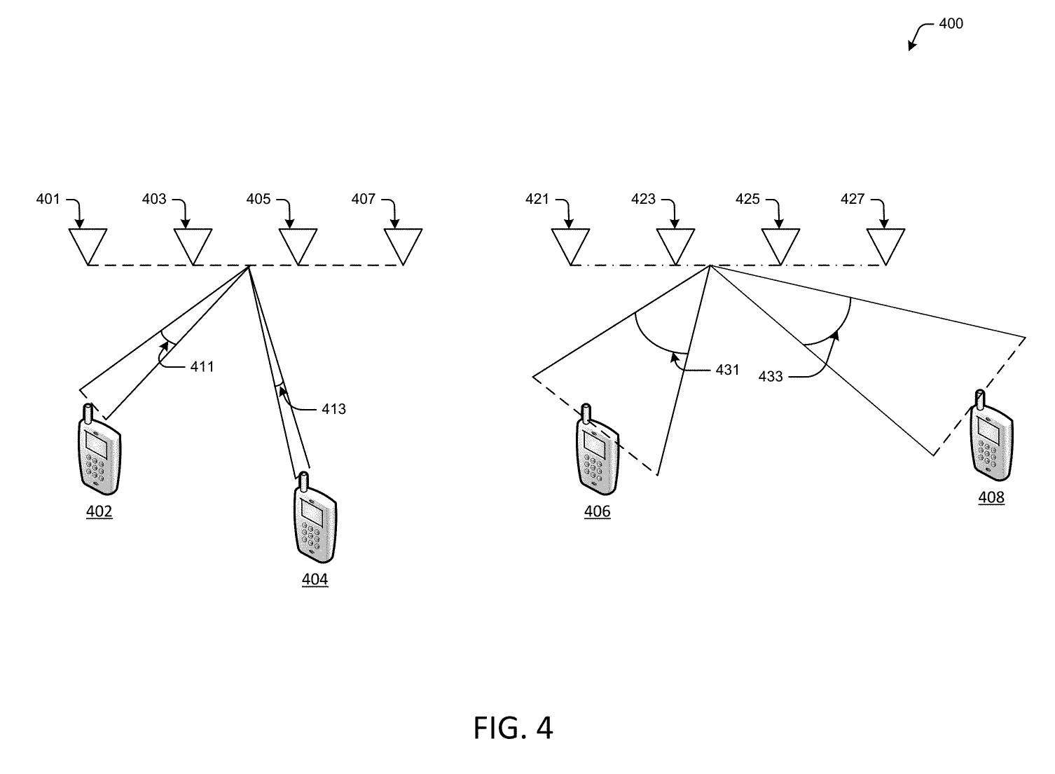

FIG. 4 depicts an illustrative multi-channel hybrid data transmission to users in different channels, according to one or more example embodiments of the disclosure. As mentioned above, narrower beam widths may be used by APs and HT UE to transmit data between the APs and HT UE, and wider beam widths may be used by APs and HRLL UE to transmit data between the APs and HRLL UE. FIG. 4 illustrates narrow band widths being used by HT UE and wider beam widths being used by HRLL UE. The multi-antenna array 400 of an access point may comprise a first RF chain comprising antennas 401, 403, 405, and 407 and a second RF chain comprising antennas 421, 423, 425, and 427. The first RF chain may transmit narrow beams 411 and 413 to HT UE 402 and 404, respectively, after beamforming training is executed as explained above. The second RF chain may transmit broad or wide beams 431 and 433 to UE 406 and 408, respectively. The first RF chain may be said to have a higher array gain than the second RF chain. Although not depicted, the first RF chain may use all four antennas to steer beams 411 and 413 toward UE 402 and 404 respectively, whereas the second RF chain may use only two antennas to steer beams 431 and 433 toward UE 406 and 408, respectively. As explained above the beam width may be inversely proportional to the number of antennas used and because the first RF chain uses double the number of antennas, beams 411 and 413 may be narrower than beams 431 and 433. Accordingly, UE 402 and 404 may be executing HT applications and UE 406 and 408 may be executing HRLL applications.

FIG. 5 is an illustrative method that may be executed by an access point to set up a connection with HT and HRLL UE in order to exchange data with the HT and HRLL UE. In particular, the method includes steps of initiating beamforming with the HT and HRLL UE, establishing a first connection, on a first channel, between a first subset of antennas, or RF chains, on the AP and the HT UE and establishing a connection, on a second channel, between a second subset of antennas, or RF chains, on the AP and the HRLL UE, refining a beam width associated with the first channel and second channel, and exchanging data with the HT UE and HRLL UE over the first and second channels. For example, with reference to FIG. 5, provided is an illustrative flow diagram for beamforming training in a network with UE having two or more different Quality of Service (QoS) requirements, such as HT and HRLL, from the perspective of the AP, according to one or more example embodiments of the disclosure. Method 500 may correspond to a series of steps that may occur in the order depicted in method 500 or in another order, and may correspond to computer-executable instructions that may be executed by a processor or one or more components in a wireless device, such as AP 140. At step 502, the method may transmit network acquisition frames to high reliability low latency (HRLL) and high throughput (HT) user equipment (UE) on a primary channel. At step 504, the method may transmit beamforming (BF) training frames to the HRLL and HT UE on the primary channel. For example, the method may transmit BF Training field 201 to the HT UE, and BF Training field 301 to the HRLL UE. At step 506, the method may receive a request for a reserved channel from the HRLL UE. At step 508, the method may determine a first number of HT UE and a second number of HRLL UE requesting a connection. At step 510, the method may determine a first set of RF chains, from a multi-antenna array, to connect to the HT UE and a second set of RF chains, from the multi-antenna array, to connect to the HRLL UE. At step 512, the method may determine a first set of channels, not comprising the primary channel, to assign to the HRLL UE. At step 514, the method may determine a first codebook to be used by the HRLL UE, wherein the first codebook may be based at least in part on the second number of HRLL UE requesting a connection and quality of service (QoS) requirements of the HRLL UE. At step 516, the method may determine a second codebook to be used by the HT UE, wherein the second codebook may be based at least in part on the first number of HT UE requesting a connection and quality of service (QoS) requirements of the HT UE. At step 518, the method may transmit a first frame on the primary channel to the HRLL UE indicating that the first codebook should be used to transmit frames or decoded received frames. At step 520, the method may transmit a second frame on the primary channel to the HT UE indicating that the second codebook should be used to transmit frames or decode received frames. At step 522, the method may initiate beamforming refinement on the first set of channels with the HRLL UE on the first set of RF chains. At step 524, the method may initiate beamforming refinement on the primary channel with the HT UE on the second set of RF chains. At step 526, the method may transmit data to the HRLL UE on the first set of channels on the first set of RF chains using code words from the first codebook. For example, the method may transmit the data in data transmission field 203. At step 528, the method may transmit data to the HT UE on the primary channel on the second set of RF chains using code words from the second codebook. For example, the method may transmit the data in data transmission field 303.

FIG. 6 depicts an illustrative flow diagram for beamforming training in a network with UE having two or more different QoS requirements, from the perspective of the UE with, for example, a HT type QoS, according to the disclosure. Method 600 may correspond to a series of steps that may occur in the order depicted in method 600 or in another order, and may correspond to computer-executable instructions that may be executed by a processor or one or more components in a wireless device, such as UE 402 or 404. At step 602, the method may receive network acquisition frames on a primary channel from an access point (AP). At step 604, the method may receive beamforming frames on the primary channel from the AP. For example, the method may receive BF training field 201. At step 606, the method may receive a frame from the AP indicating that a first codebook should be used to transmit frames or decode frames received from the AP on the primary channel, wherein the first codebook is associated with a narrow beam width. The first codebook may comprise a greater number of code words because a greater number of beams with narrower beam widths may be produced. For example, if each beam width generated by the antenna array of the access point is 30 degrees for HT UE, and a total area of 120 degrees may be covered by the antenna array, then four code words may be generated to cover the entire area. Similarly for HRLL UE, for example, if each beam width generated by the antenna array of the access point is 60 degrees for HRLL, then only two words may be generated to cover the entire area. Thus the cardinality, or size, of the first codebook may be greater than the cardinality of the second codebook. At step 608, the method may initiate beamforming refinement with the AP on the primary channel. At step 610, the method may receive data from the AP on the primary channel. For example, the method may receive data in data transmission field 203. At step 612, the method may decode the data from the AP using the first codebook.

FIG. 7 depicts an illustrative flow diagram for beamforming training in a network with UE having two or more different QoS requirements, from the perspective of the UE with, for example, a HRLL type QoS, according to the disclosure. Method 700 may correspond to a series of steps that may occur in the order depicted in method 700 or in another order, and may correspond to computer-executable instructions that may be executed by a processor or one or more components in a wireless device, such as UE 406 or 408. At step 702, the method may receive network acquisition frames on a primary channel from an access point (AP). At step 704, the method may receive beamforming frames on the primary channel from the AP. For example, the method may receive BF training field 301. At step 706, the method may receive a frame from the AP indicating that a second codebook should be used to transmit frames or decode frames received from the AP on a secondary channel, wherein the second codebook is associated with a wide beam width. At step 708, the method may initiate beamforming refinement with the AP on the secondary channel. At step 710, the method may receive data from the AP on the primary channel. For example, the method may receive data transmission field 303. At step 712, the method may decode the data from the AP using the second codebook.

In some embodiments, multiple UE executing TSN applications may be paired or connected to the same AP and may use the same channel given that they are separated enough spatially so that multiuser digital beamforming can orthogonalize the UE in space. For instance, if there are a plurality of UE executing TSN applications and each of the UE are separated by at least a minimum required distance from one another, a code may be assigned to each of the UE such that each UE transmission appears as noise to the other UE thereby eliminating any interference that may be experienced by simultaneous transmission by the UE. The access point may orthogonalized the UE in space by generating a codebook, wherein the codebook comprises orthogonal code words. That is, each code word in the codebook may be orthogonal to all of the other code words in the codebook if each code word can be multiplied by the remaining code words and the resulting product is equal to zero. In particular, each code word may be represented as a vector and if the dot product of each vector corresponding to a code word is equal to zero when the dot product of the vector and the vectors corresponding to the other code words in the codebook, then the code word is said to be orthogonal to the other code words in the codebook. For example, a first code word comprising the bit sequence a=(a₁,a₂,a₃,a₄,a₅)=(10110), is orthogonal to a second code word comprising the bit sequence b=(b₁,b₂,b₃,b₄,b₅)=(01001) because the dot product of a and b is equal to (a₁b₁,a₂b₂,a₃b₃,a₄b₄,a₅b₅)=0, and wherein a₁bⱼ=aᵢ×bⱼ for i=j=1, 2, 3, 4, 5. It should be noted that this is exemplary and i and j can be equal to any natural number.

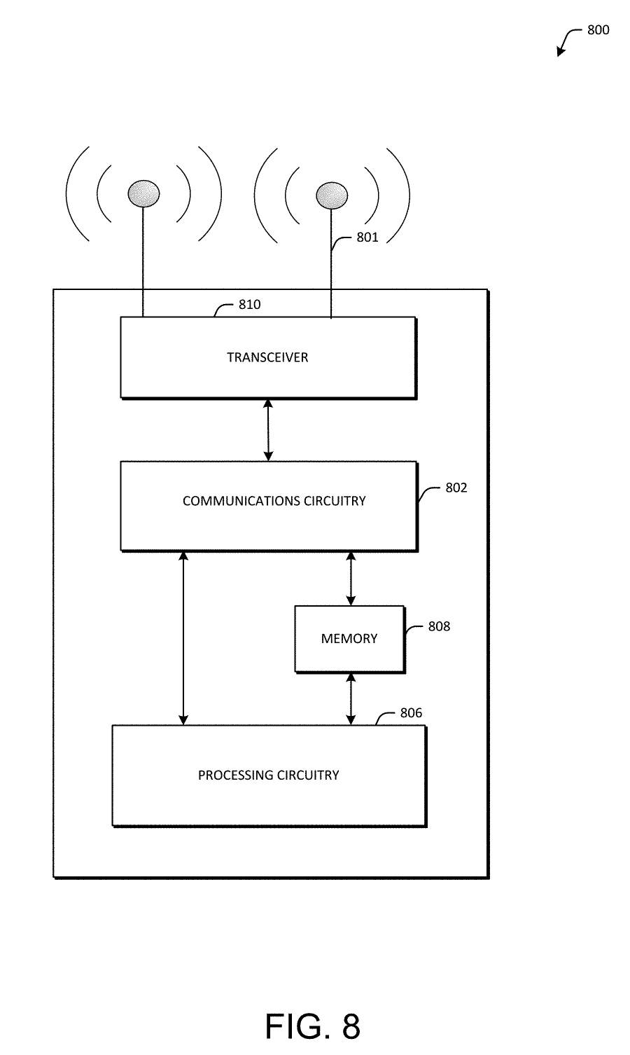

FIG. 8 shows a functional diagram of an exemplary communication station 800 in accordance with some embodiments. In one embodiment, FIG. 8 illustrates a functional block diagram of a communication station that may be suitable for use as an AP (e.g., 140) in FIGS. 1 and 4 and the associated method of FIG. 6 or and user equipment (UE) (e.g., UE 104) in FIGS. 1 and 4, and the associated methods of FIGS. 5 and 6 in accordance with some embodiments. The communication station 800 may also be suitable for use as a handheld device, mobile device, cellular telephone, smartphone, tablet, netbook, wireless terminal, laptop computer, wearable computer device, femtocell, HiGH Data Rate (HDR) subscriber station, access point, access terminal, or other personal communication system (PCS) device.

The communication station 800 may include communications circuitry 802 and a transceiver 810 for transmitting and receiving signals to and from other communication stations using one or more antennas 801. The communications circuitry 802 may include circuitry that can operate the physical layer communications and/or medium access control (MAC) communications for controlling access to the wireless medium, and/or any other communications layers for transmitting and receiving signals. The communication station 800 may also include processing circuitry 806 and memory 808 arranged to perform the operations described herein. In some embodiments, the communications circuitry 802 and the processing circuitry 806 may be configured to perform operations detailed as a method in FIGS. 5-7.

In accordance with some embodiments, the communications circuitry 802 may be arranged to contend for a wireless medium and configure frames or packets for communicating over the wireless medium. The communications circuitry 802 may be arranged to transmit and receive signals. The communications circuitry 802 may also include circuitry for modulation/demodulation, upconversion/downconversion, filtering, amplification, etc. In some embodiments, the processing circuitry 806 of the communication station 800 may include one or more processors. In other embodiments, two or more antennas 801 may be coupled to the communications circuitry 802 arranged for sending and receiving signals. The memory 808 may store information for configuring the processing circuitry 806 to perform operations for configuring and transmitting message frames and performing the various operations described herein. The memory 808 may include any type of memory, including non-transitory memory, for storing information in a form readable by a machine (for example, a computer). For example, the memory 808 may include a computer-readable storage device may, read-only memory (ROM), random-access memory (RAM), magnetic disk storage media, optical storage media, flash-memory devices and other storage devices and media.

In some embodiments, the communication station 800 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (for example, a heart rate monitor, a blood pressure monitor, etc.), a wearable computer device, or another device that may receive and/or transmit information wirelessly.

In some embodiments, the communication station 800 may include one or more antennas 801. The antennas 801 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 800 may include one or more of a keyboard, a display, a non-volatile memory port, multiple antennas, a graphics processor, an application processor, speakers, and other mobile device elements. The display may be an LCD screen including a touch screen.

Although the communication station 800 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 800 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (for example, a computer). For example, a computer-readable storage device may include read-only memory (ROM), random-access memory (RAM), magnetic disk storage media, optical storage media, flash-memory devices, and other storage devices and media. In some embodiments, the communication station 800 may include one or more processors and may be configured with instructions stored on a computer-readable storage device memory.

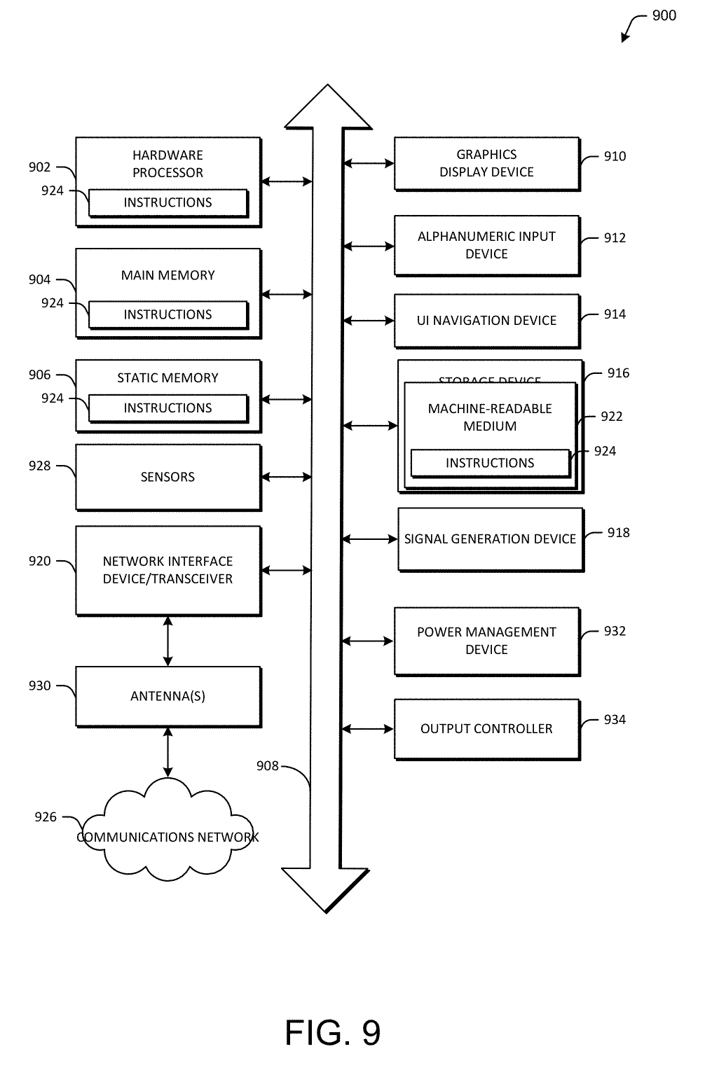

FIG. 9 illustrates a block diagram of an example of a machine 900 or system upon which any one or more of the techniques (for example, methodologies) discussed herein may be performed. The machine 900 may include the functionality of the APs and/or UE described herein with respect to FIGS. 1-7. In other embodiments, the machine 900 may operate as a standalone device or may be connected (for example, networked) to other machines. In a networked deployment, the machine 900 may operate in the capacity of a server machine, a client machine, or both in server-client network environments. In an example, the machine 900 may act as a peer machine in peer-to-peer (P2P) (or other distributed) network environments. The machine 900 may be a personal computer (PC), a tablet PC, a set-top box (STB), a personal digital assistant (PDA), a mobile telephone, wearable computer device, a web appliance, a network router, switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (for example, hardware) capable of performing specified operations when operating. A module includes hardware. In an example, the hardware may be specifically configured to carry out a specific operation (for example, hardwired). In another example, the hardware may include configurable execution units (for example, transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (for example, computer system) 900 may include a hardware processor 902 (for example, a central processing unit (CPU), a graphics processing unit (GPU), a hardware processor core, or any combination thereof), a main memory 904 and a static memory 906, some or all of which may communicate with each other via an interlink (for example, bus) 908. The machine 900 may further include a power management device 932, a graphics display device 910, an alphanumeric input device 912 (for example, a keyboard), and a user interface (UI) navigation device 914 (for example, a mouse). In an example, the graphics display device 910, alphanumeric input device 912, and UI navigation device 914 may be a touch screen display. The machine 900 may additionally include a storage device (i.e., drive unit) 916, a signal generation device 918 (for example, a speaker), an aggregation and enhanced transmission of small packets device 919, a network interface device/transceiver 920 coupled to antenna(s) 930, and one or more sensors 928, such as a global positioning system (GPS) sensor, compass, accelerometer, or other sensor. The machine 900 may include an output controller 934, such as a serial (for example, universal serial bus (USB), parallel, or other wired or wireless (for example, infrared (IR), near field communication (NFC), etc.) connection to communicate with or control one or more peripheral devices (for example, a printer, card reader, etc.)).

The storage device 916 may include a machine readable medium 922 on which is stored one or more sets of data structures or instructions 924 (for example, software) embodying or utilized by any one or more of the techniques or functions described herein. The instructions 924 may also reside, completely or at least partially, within the main memory 904, within the static memory 906, or within the hardware processor 902 during execution thereof by the machine 900. In an example, one or any combination of the hardware processor 902, the main memory 904, the static memory 906, or the storage device 916 may constitute machine-readable media.

The instructions 924 may carry out or perform any of the operations and processes (for example, processes 300-1300) described and shown above. While the machine-readable medium 922 is illustrated as a single medium, the term “machine-readable medium” may include a single medium or multiple media (for example, a centralized or distributed database, and/or associated caches and servers) configured to store the one or more instructions 924.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 900 and that cause the machine 900 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (for example, Electrically Programmable Read-Only Memory (EPROM), or Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 924 may further be transmitted or received over a communications network 926 using a transmission medium via the network interface device/transceiver 920 utilizing any one of a number of transfer protocols (for example, frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (for example, the Internet), mobile telephone networks (for example, cellular networks), Plain Old Telephone (POTS) networks, wireless data networks (for example, Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 920 may include one or more physical jacks (for example, Ethernet, coaxial, or phone jacks) or one or more antennas to connect to the communications network 926. In an example, the network interface device/transceiver 920 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 900 and includes digital or analog communications signals or other intangible media to facilitate communication of such software. The operations and processes (for example, processes 600-900) described and shown above may be carried out or performed in any suitable order as desired in various implementations. Additionally, in certain implementations, at least a portion of the operations may be carried out in parallel. Furthermore, in certain implementations, less than or more than the operations described may be performed.

The word “exemplary” is used herein to mean “serving as an example, instance, or illustration.” Any embodiment described herein as “exemplary” is not necessarily to be construed as preferred or advantageous over other embodiments. The terms “computing device”, “user device”, “communication station”, “station”, “handheld device”, “mobile device”, “wireless device” and “user equipment” (UE) as used herein refers to a wireless communication device such as a cellular telephone, smartphone, tablet, netbook, wireless terminal, laptop computer, a femtocell, HiGH Data Rate (HDR) subscriber station, access point, printer, point of sale device, access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as ‘communicating’, when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

The term “access point” (AP) as used herein may be a fixed station. An access point may also be referred to as an access node, a base station, or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, for example, a Smartphone, a Wireless Application Protocol (WAP) device, or the like.

Some embodiments may be used in conjunction with one or more types of wireless communication signals and/or systems following one or more wireless communication protocols, for example, Radio Frequency (RF), Infra Red (IR), Frequency-Division Multiplexing (FDM), Orthogonal FDM (OFDM), time-Division Multiplexing (TDM), time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), Global System for Mobile communication (GSM), 2G, 2.5G, 3G, 3.5G, 4G, Fifth Generation (5G) mobile networks, 3GPP, Long Term Evolution (LTE), LTE advanced, Enhanced Data rates for GSM Evolution (EDGE), or the like. Other embodiments may be used in various other devices, systems, and/or networks.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Various embodiments of the invention may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that can direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

In example embodiments of the disclosure, there may be a device, comprising a memory and processing circuitry configured to: cause to send a network acquisition frame to a first device and a second device on a primary channel; cause to send a first beamforming training frame to the first device and a second beamforming training frame to the second device on the primary channel, wherein the first beamforming training frame comprises a first set of bits and second beamforming training frame comprises a second set of bits wherein the first set of bits is larger than the second set of bits; determine a first set of RF chains, from a multi-antenna array, to establish a first connection on with the first device, and a second set of RF chains, from the multi-antenna array, to establish a second connection on with the second device; determine a first set of channels to assign to the second device; determine a first codebook to transmit to the first device, and a second codebook to transmit to the second device; cause to send the first codebook to the first device, and the second codebook to the second device; cause to initiate a first beamforming refinement on the primary channel with the first device, and a second beamforming refinement on the first set of channels with the second device; and cause to send a first set of data to the first device on the primary channel, and a second set of data to the second device on the first set of channels.

Implementations may include the following features. The first beamforming training frame may correspond to a first beam width associated with the first device, and the first device may be a high throughput (HT) user equipment (UE) device. The second beamforming training frame may correspond to a second beam width associated with the first devices, and the first device may be a high reliability low latency (HRLL) user equipment (UE) device, and the first beam width may be narrower than the second beam width. The memory and processing circuitry may be further configured to identify a request for a reserved channel received from the second device. The memory and processing circuitry may be further configured to determine a first number of HT UE devices connected to the device, and a second number of HRLL UE devices connected to the device. The first codebook may be based at least in part on the first number of HT UE devices, and the second codebook may be based at least in part on the second number of HRLL UE devices. The first codebook may be based at least in part on a first quality of service (QoS) requirement associated with the first device, and the first QoS requirement may be based at least in part on the processing circuitry executing a first application requiring a high throughput. The second codebook may be based at least in part on a second QoS requirement associated with the second device, and the second QoS may be based at least in part on the processing circuitry executing a second application requiring high reliability and low latency. The device may further comprise at least one transceiver and the multi-antenna array may be configured to transmit or receive electromagnetic radiation associated with a signal.

In example embodiments of the disclosure, there may be a non-transitory computer-readable medium storing computer-executable instructions which, when executed by a processor, may cause the processor to perform operations comprising: causing to send a network acquisition frame to a first device and a second device on a primary channel; causing to send a first beamforming training frame to the first device and a second beamforming training frame to the second device on the primary channel wherein the first beamforming training frame comprises a first set of bits and second beamforming training frame comprises a second set of bits wherein the first set of bits is larger than the second set of bits; determining a first set of RF chains, from a multi-antenna array, to establish a first connection on with the first device, and a second set of RF chains, from the multi-antenna array, to establish a second connection on with the second device; determining a first set of channels to assign to the second device; determining a first codebook to transmit to the first device, and a second codebook to transmit to the second device; causing to transmit the first codebook to the first device, and the second codebook to the second device; causing to initiate a first beamforming refinement on the primary channel with the first device, and a second beamforming refinement on the first set of channels with the second device; and causing to send a first set of data to the first device on the primary channel, and a second set of data to the second device on the first set of channels.

Implementations may include the following features. The first beamforming training frame may correspond to a first beam width associated with the first device, and wherein the first device may be a high throughput (HT) user equipment (UE) device. The second beamforming training frame may correspond to a second beam width associated with the second device, and the second device may be a high reliability low latency (HRLL) UE device, and the first beam width is narrower than the second beam width. The computer-executable instructions, which when executed by the processor, may further cause the processor to perform the operations comprising identifying a request for a reserved channel received from the second device. The first set of channels may not comprise the primary channel. The computer-executable instructions, which when executed by the processor, may further cause the processor to perform the operations determining a first number of HT UE devices connected to the device, and a second number of HRLL UE devices connected to the device. The first codebook may be based at least in part on the first number of HT UE devices, and the second codebook may be based at least in part on the second number of HRLL UE devices. The first codebook may be based at least in part on a first quality of service (QoS) requirement associated with the first device, and the first QoS requirement may be based on at least in part on the processing circuity executing a first application requiring a high throughput. The second codebook may be based at least in part on a second QoS requirement associated with the second device, and the second QoS may be based at least in part on the processing circuitry executing a second application requiring high reliability and low latency.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

1. A device, the device comprising:
memory and processing circuitry configured to:
cause to send a network acquisition frame to a first device and a second device on a primary channel;
cause to send a first beamforming training frame to the first device and a second beamforming training frame to the second device on the primary channel, wherein the first beamforming training frame comprises a first set of bits and second beamforming training frame comprises a second set of bits wherein the first set of bits is larger than the second set of bits;
determine a first set of RF chains, from a multi-antenna array, to establish a first connection on which the first device, and a second set of RF chains, from the multi-antenna array, to establish a second connection on which the second device;
determine a first set of channels to assign to the second device;
determine a first codebook to transmit to the first device, and a second codebook to transmit to the second device;
cause to send the first codebook to the first device, and the second codebook to the second device;
cause to initiate a first beamforming refinement on the primary channel with the first device, and a second beamforming refinement on the first set of channels with the second device; and
cause to send a first set of data to the first device on the primary channel, and a second set of data to the second device on the first set of channels.

2. The device of claim 1, wherein:
the first beamforming training frame corresponds to a first beam width associated with the first device, and wherein the first device is a high throughput (HT) user equipment (UE) device; and
the second beamforming training frame corresponds to a second beam width associated with the first devices, and wherein the first device is a high reliability low latency (HRLL) user equipment (UE) device, and the first beam width is narrower than the second beam width.

3. The device of claim 1, wherein the memory and processing circuitry is further configured to:
identify a request for a reserved channel received from the second device.

4. The device of claim 1, wherein the first set of channels does not comprise the primary channel.

5. The device of claim 1, wherein the memory and processing circuitry is further configured to:
determine a first number of HT UE devices connected to the device, and a second number of HRLL UE devices connected to the device.

6. The device of claim 5, wherein the first codebook is based at least in part on the first number of HT UE devices, and the second codebook is based at least in part on the second number of HRLL UE devices.

7. The device of claim 1, wherein the first codebook is based at least in part on a first quality of service (QoS) requirement associated with the first device, and the first QoS requirement is based on at least in part on the processing circuitry executing a first application requiring a high throughput.

8. The device of claim 1, wherein the second codebook is based at least in part on a second QoS requirement associated with the second device, and the second QoS requirement is based at least in part on the processing circuitry executing a second application requiring high reliability and low latency.

9. The device of claim 1, further comprising at least one transceiver.

10. The device of claim 9, wherein the multi-antenna array is electrically coupled to the at least one transceiver, wherein the multi-antenna array is configured to transmit or receive electromagnetic radiation associated with a signal.

11. A non-transitory computer-readable medium storing computer-executable instructions which, when executed by a processor, cause the processor to perform operations comprising:
causing to send a network acquisition frame to a first device and a second device on a primary channel;
causing to send a first beamforming training frame to the first device and a second beamforming training frame to the second device on the primary channel wherein the first beamforming training frame comprises a first set of bits and second beamforming training frame comprises a second set of bits wherein the first set of bits is larger than the second set of bits;
determining a first set of RF chains, from a multi-antenna array, to establish a first connection on which the first device, and a second set of RF chains, from the multi-antenna array, to establish a second connection on which the second device;
determining a first set of channels to assign to the second device;
determining a first codebook to transmit to the first device, and a second codebook to transmit to the second device;
causing to transmit the first codebook to the first device, and the second codebook to the second device;
causing to initiate a first beamforming refinement on the primary channel with the first device, and a second beamforming refinement on the first set of channels with the second device; and
causing to send a first set of data to the first device on the primary channel, and a second set of data to the second device on the first set of channels.

12. The non-transitory computer-readable medium of claim 11, wherein:
the first beamforming training frame corresponds to a first beam width associated with the first device, and wherein the first device is a high throughput (HT) user equipment (UE) device; and
the second beamforming training frame corresponds to a second beam width associated with the second device, and wherein the second device is a high reliability low latency (HRLL) UE device, and the first beam width is narrower than the second beam width.

13. The non-transitory computer-readable medium of claim 11, wherein the computer-executable instructions, which when executed by the processor, further cause the processor to perform the operations comprising:
identifying a request for a reserved channel received from the second device.

14. The non-transitory computer-readable medium of claim 11, wherein the first set of channels does not comprise the primary channel.

15. The non-transitory computer-readable medium of claim 11, wherein the computer-executable instructions, which when executed by the processor, further cause the processor to perform the operations comprising:
determining a first number of HT UE devices connected to the device, and a second number of HRLL UE devices connected to the device.

16. The non-transitory computer-readable medium of claim 15, wherein the first codebook is based at least in part on the first number of HT UE devices, and the second codebook is based at least in part on the second number of HRLL UE devices.

17. The non-transitory computer-readable medium of claim 11, wherein the first codebook is based at least in part on a first quality of service (QoS) requirement associated with the first device, and the first QoS requirement is based on at least in part on the processing circuitry executing a first application requiring a high throughput.

18. The non-transitory computer-readable medium of claim 11, wherein the second codebook is based at least in part on a second QoS requirement associated with the second device, and the second QoS requirement is based at least in part on the processing circuitry executing a second application requiring high reliability and low latency.

19. A method comprising:
causing to send a network acquisition frame to a first device and a second device on a primary channel;
causing to send a first beamforming training frame to the first device and a second beamforming training frame to the second device on the primary channel wherein the first beamforming training frame comprises a first set of bits and second beamforming training frame comprises a second set of bits wherein the first set of bits is larger than the second set of bits;
determining a first set of RF chains, from a multi-antenna array, to establish a first connection on which the first device, and a second set of RF chains, from the multi-antenna array, to establish a second connection on which the second device;
determining a first set of channels to assign to the second device;
determining a first codebook to transmit to the first device, and a second codebook to transmit to the second device;
causing to transmit the first codebook to the first device, and the second codebook to the second device;
causing to initiate a first beamforming refinement on the primary channel with the first device, and a second beamforming refinement on the first set of channels with the second device; and
causing to send a first set of data to the first device on the primary channel, and a second set of data to the second device on the first set of channels.

20. The device of claim 11, wherein:
the first beamforming training frame corresponds to a first beam width associated with the first device, and wherein the first device is a high throughput (HT) user equipment (UE) device; and
the second beamforming training frame corresponds to a second beam width associated with the second device, and wherein the second device is a high reliability low latency (HRLL) UE device, and the first beam width is narrower than the second beam width.
